(19) United States
(12) Patent Application Publication
(10) Pub. No.: US 2010/0309230 A1
(43) Pub. Date: Dec. 9, 2010

(54) LIGHT EMITTING DEVICE AND METHOD OF DRIVING THE SAME

(76) Inventor: Duck-Gu Cho, Suwon-si (KR)

Correspondence Address: CHRISTIE, PARKER & HALE, LLP, PO BOX 7068, PASADENA, CA, 91109-7068, US

(21) Appl. No.: 12/625,447

(22) Filed: Nov. 24, 2009

(30) Foreign Application Priority Data
Jun. 8, 2009 (KR) 10-2009-0050481

(51) Int. Cl. G09G 3/36; G09G 5/10

(52) U.S. Cl. 345/690; 345/94

(57) ABSTRACT

A light emitting device and a method of driving capable of reducing or preventing motion blur and flicker phenomena. The light emitting device includes: scan lines; light emitting pixels configured to provide light to a liquid crystal pixel, each of the scan lines being applied with first and second scan signals for a frame period; and a partial brightness controller is configured to generate a synchronous signal and a segment detection signal, the synchronous signal and the segment detector signal being for controlling application time points of the first and second scan signals according to a liquid crystal response speed on an operation mode basis of the crystal pixel. The first scan signal is applied at a time point at which liquid crystal arrangement of crystal pixel starts to be sustained, and the second scan signal is applied within a time period in which the liquid crystal arrangement is sustained.

### CROSS-REFERENCE TO RELATED APPLICATION

This application claims priority to and the benefit of Korean Patent Application No. 10-2009-0050481 filed in the Korean Intellectual Property Office on Jun. 8, 2009, the entire contents of which are incorporated herein by reference.

### BACKGROUND

1. Field

The following description relates generally to a light emitting device and a method of driving the same. More particularly, the following description relates generally to a light emitting device that emits light using electron emission characteristics due to an electric field, and a method of driving the same.

2. Description of the Related Art

A liquid crystal display (LCD), which is a flat panel display, is a display device that displays an image by changing a light transmission amount on a pixel using dielectric anisotropy of liquid crystal having a twist angle that changes according to an applied voltage. Compared with a cathode ray tube, which is a typical image display device, the LCD is lighter in weight and thinner in thickness, and consumes less power. The LCD includes a liquid crystal panel assembly and a light emitting device that is positioned at a rear side of the liquid crystal panel assembly to provide light to the liquid crystal panel assembly.

When the liquid crystal panel assembly is formed with an active liquid crystal panel assembly, the liquid crystal panel assembly includes a pair of transparent substrates, a liquid crystal layer that is positioned between the transparent substrates, a polarizing plate that is disposed at an outer surface of the transparent substrates, a common electrode that is provided in an internal surface of one of the transparent substrates, pixel electrodes and switches that are provided in an internal surface of the other one of the transparent substrates, and a color filter that provides red, green, and blue colors to three sub-pixels constituting a pixel. Here, in one embodiment, the liquid crystal layer is made of a polymer material and does not quickly respond to a change of an electric field, and liquid crystal molecules thereof may only be in a stable arrangement state after a set or predetermined time period. Response speed of the liquid crystal molecules is related to viscosity and elastic force thereof. The response speed is determined by a rising time (or a liquid crystal rising time) and a falling time (or a liquid crystal falling time). The rising time is a time period in which the liquid crystal molecules are aligned due to an electric field formed in the liquid crystal layer, and the falling time is a time period necessary for returning the arrangement of the aligned liquid crystal molecules to an original state when the electric field is no longer formed in the liquid crystal layer. The rising time and/or the falling time can be obtained by measuring a time period in which light transmittance of the liquid crystal display panel changes. The rising time indicates a time period necessary for changing light transmittance from 10% to 90%, and the falling time indicates a time period necessary for changing light transmittance from 90% to 10%.

As a light source of the light emitting device, a fluorescent lamp of a structure with a surface light source having uniform brightness is used. The fluorescent lamp uses a cold cathode fluorescent lamp (CCF) that can emit light with a high luminance while having a small size. In a light emitting device using a cold cathode fluorescent lamp, because light sources are always turned on, a flicker phenomenon in which a screen flickers does not occur. However, in an image having a fast motion, a motion blur phenomenon in which a dim after-image is displayed on a screen may occur. In order to improve the problem, as a light source of the light emitting device, an electron emission element is used and an impulsive scanning driving method is selected. As in a cathode ray tube, the electron emission element has a merit of being operated by cathode electrode line light emission, and has a fast operation speed and a wide operation temperature range. Particularly, as the electron emission element, a carbon nanotube (CNT) having good light emitting efficiency is used. An impulsive scanning driving method is a method of turning on light sources of a light emitting device in a time period in which an image is displayed for a frame, and turning off light sources for the remaining period. In such a method, because an after-image of a previous frame can be removed, the motion blur phenomenon can be improved. However, during a liquid crystal rising time, when an image is being input, light sources (or light emitting pixels) of a light emitting device are already turned on, and thus a motion blur phenomenon may occur for this time period. Further, even in a still picture having no abrupt change of screen, there is a problem that a flicker phenomenon occurs, as in a cathode ray tube.

The above information disclosed in this Background section is only for enhancement of understanding of the background of the described technology and therefore it may contain information that does not form the prior art that is already known in this country to a person of ordinary skill in the art.

### SUMMARY

Aspects of embodiments of the present invention are directed toward a light emitting device and a method of driving the same capable of reducing or even preventing motion blur and flicker phenomena.

An exemplary embodiment provides a light emitting device configured as a light source for a display device including a plurality of liquid crystal pixels. The light emitting device includes a display unit and a partial brightness controller. The display unit includes a plurality of scan lines, a plurality of column lines, and a plurality of light emitting pixels configured to provide light to at least one of the plurality of liquid crystal pixels, wherein each of the plurality of scan lines is configured to be applied with a first scan signal and a second scan signal for a frame period. The partial brightness controller is configured to generate a synchronous signal and a segment detection signal, the synchronous signal and the segment detector signal being for controlling application time points of the first and second scan signals according to a liquid crystal response speed on an operation mode basis of the display device. Here, the first scan signal is applied at a time point of the application time points at which liquid crystal arrangement of the plurality of liquid crystal pixels starts to be sustained, and the second scan signal is applied within a time period in which the liquid crystal arrangement is sustained.

In one embodiment, the liquid crystal response speed includes a rising time, a sustaining time, and a falling time; the rising time is a time period from a time point at which a voltage is applied to the display device until the liquid crystal arrangement changes from an initial state to a sustain state; the sustaining time is a time period in which the liquid crystal arrangement is in the sustain state; and the falling time is a time period from a time point at which the application of the voltage to the display device is terminated until the liquid crystal arrangement returns to the initial state. Here, the partial brightness controller may be configured to generate and apply the synchronous signal at a time point at which the rising time terminates and/or to generate and apply the segment detection signal from a time point at which the rising time terminates until a time point at which the falling time starts.

In one embodiment, the light emitting device further includes a controller configured to apply the first scan signal to each of the plurality of scan lines at a time point at which the synchronous signal is applied and to apply the second scan signal to each of the plurality of scan lines within a time period in which the segment detection signal is applied.

Another exemplary embodiment provides a method of driving a light emitting device including a plurality of scan lines, a plurality of column lines, and a plurality of light emitting pixels configured to provide a light to at least one of a plurality of liquid crystal pixels of a display device. The method includes: applying a first scan signal and a second scan signal to each of the plurality of scan lines for a frame period; and generating a synchronous signal and a segment detection signal for controlling application time points of the first and second scan signals according to a liquid crystal response speed on an operation mode basis of the display device. Here, the first scan signal is applied at a time point of the application time points at which liquid crystal arrangement of the plurality of liquid crystal pixels starts to be sustained, and the second scan signal is applied within a time period in which the liquid crystal arrangement is sustained.

In one embodiment, the liquid crystal response speed includes a rising time, a sustaining time, and a falling time; the rising time is a time period from a time point at which a voltage is applied to the display device until the liquid crystal arrangement changes from an initial state to a sustain state; the sustaining time is a time period in which the liquid crystal arrangement is in the sustain state; and the falling time is a time period from a time point at which the application of the voltage to the display device is terminated until the liquid crystal arrangement returns to the initial state. Here, the method may further include generating the synchronous signal at a time point at which the rising time terminates. and/or generating the segment detection signal from a time point at which the rising time terminates until a time point at which the falling time starts.

As described above, according to the embodiments of the present invention, by applying a first scan signal and a second scan signal within a period in which arrangement of liquid crystal is sustained, motion blur and flicker phenomena can be reduce or even prevented.

### BRIEF DESCRIPTION OF THE DRAWINGS

FIG. 1 is a block diagram illustrating a configuration of an LCD according to an exemplary embodiment.

FIG. 2 is an equivalent circuit diagram of a liquid crystal pixel PX that is shown in FIG. 1.

FIG. 3 is a diagram illustrating a synchronous signal Sync, a segment detection signal ID, and a scan signal that is supplied to a plurality of scan lines S1-Sp according to an exemplary embodiment.

### DETAILED DESCRIPTION

In the following detailed description, certain exemplary embodiments have been shown and described, simply by way of illustration. As those skilled in the art would realize, the described embodiments may be modified in various different ways, all without departing from the spirit or scope of the embodiment. Accordingly, the drawings and description are to be regarded as illustrative in nature and not restrictive. Like reference numerals designate like elements throughout the specification.

Throughout this specification and the claims that follow, when it is described that an element is “coupled” or “connected” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

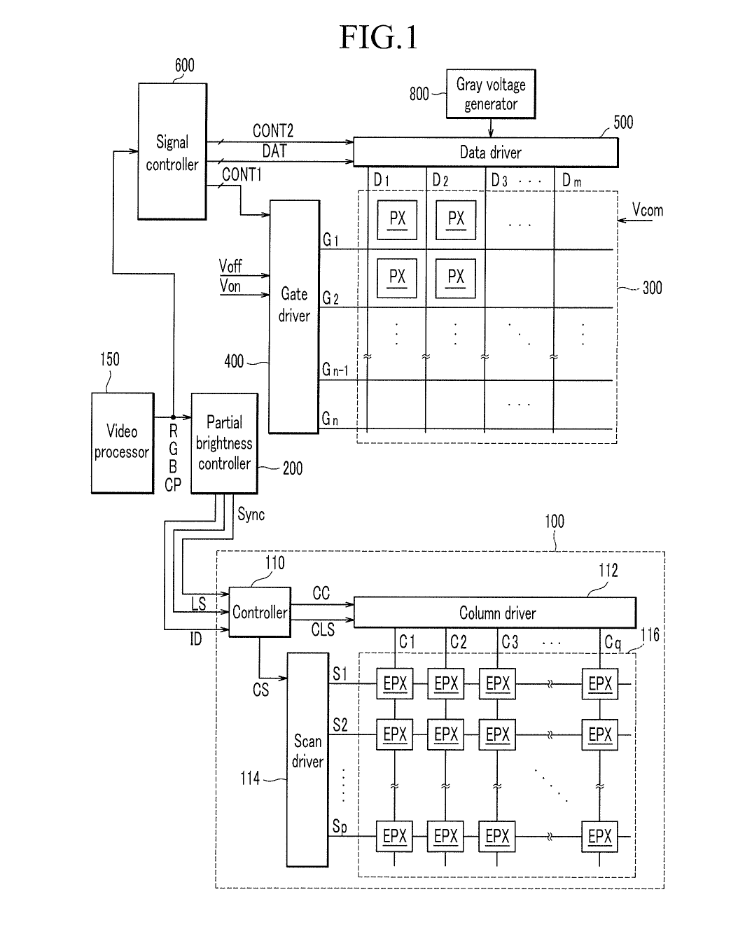

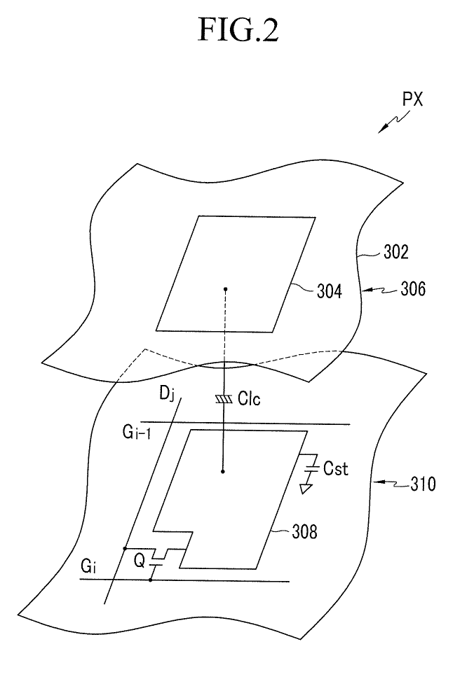

FIG. 1 is a block diagram illustrating a configuration of an LCD according to an exemplary embodiment, and FIG. 2 is an equivalent circuit diagram of a liquid crystal pixel PX that is shown in FIG. 1.

Referring to FIG. 1, the LCD according to the present exemplary embodiment includes a light emitting device 100, a video processor 150, a partial brightness controller 200, a liquid crystal panel assembly 300, a gate driver 400, a data driver 500, a signal controller 600, and a gray voltage generator 800.

The video processor 150 receives an image source that is transmitted from various media to convert the image source to an input image control signal CP that displays an image according to input video signals R, G, and B and an input image corresponding to a resolution of the LCD. The generated input video signals R, G, and B and input image control signal CP are input to the partial brightness controller 200 and the signal controller 600. The input video signals R, G, and B include luminance information of each liquid crystal pixel PX, and luminance has grays (or gray levels) of a determined number, for example, 1024 (=2¹⁰), 256 (=2⁸), or 64 (=2⁶). The input image control signal CP includes input video signals R, G, and B and control signals Hsync, Vsync, MCLK, and DE that are necessary for displaying the input video signals R, G, and B.

The partial brightness controller 200 receives the input video signals R, G, and B and the input image control signal CP, and outputs a brightness information signal LS. The partial brightness controller 200 reads the input video signals R, G, and B and the input image control signal CP, and generates a brightness information signal LS representing brightness information of each of a plurality of light emitting pixels EXP of the light emitting device 100. Specifically, the partial brightness controller 200 reads the input video signals R, G, and B and the input image control signal CP, detects a highest gray (or a highest gray level) of a plurality of liquid crystal pixels PX corresponding to a light emitting pixel EXP of the light emitting device 100, and determines a gray (or a gray level) of a corresponding light emitting pixel EXP according to the detected gray (or the detected gray level). The partial brightness controller 200 generates a brightness information signal LS representing the determined gray (or the determined gray level).

Further, the partial brightness controller 200 generates a synchronous signal Sync and a segment detection signal ID that control the light emitting device 100 according to a liquid crystal response speed on a driving mode basis of the liquid crystal panel assembly 300. The liquid crystal panel assembly 300 can be embodied in various modes in order to adjust a viewing angle of the liquid crystal panel. For example, the various modes include a twisted nematic mode (TN mode) that controls a liquid crystal direction indicator by applying a voltage to the liquid crystal direction indicator after arranging the liquid crystal direction indicator to be twisted with an angle of 90°, a multi-domain mode that embodies a wide viewing angle by dividing a pixel into several domains and changing a main viewing angle direction of each domain, an optically compensated birefringence mode (OCB mode) that compensates a phase change of light according to an advancing direction of light by attaching a compensation film to an outer circumferential surface of a substrate, an in-plane switching mode that twists a liquid crystal direction indicator in parallel surfaces of alignment films by forming two electrodes on a substrate, and a vertical alignment mode (VA mode) that vertically arranges a major axis of a liquid crystal molecule (or major axes of liquid crystal molecules) in a plane of a vertical alignment film using a negative type liquid crystal and the vertical alignment film. According to a driving mode of the liquid crystal panel assembly 300, liquid crystal characteristics of the liquid crystal panel assembly 300 are determined within certain specifications. In an exemplary embodiment, a dual scanning mode that applies a first scan signal and a second signal to each of a plurality of scan lines S1-Sp for a frame period is embodied. In the present exemplary embodiment, in order to embody a dual scanning mode, applying time points of a first scan signal and a second scan signal that are applied to each of the plurality of scan lines S1-Sp are controlled using a synchronous signal Sync and a segment detection signal ID. Specifically, the synchronous signal Sync occurs at a time point that has elapsed by a rising time from a time point at which a set or predetermined pixel voltage is applied to the liquid crystal panel assembly 300. Response characteristics of the liquid crystal panel assembly 300 are determined by a rising time, a sustaining time, and a falling time. The rising time is a time period that is necessary from a time point at which a set or predetermined pixel voltage is applied to the liquid crystal panel assembly 300 until the arrangement of the liquid crystal molecules is stabilized. The sustaining time is a time period in which the arrangement of the stabilized liquid crystal molecules is sustained, and the falling time is a time period from a time point at which application of the pixel voltage to the liquid crystal panel assembly 300 is terminated to a time point at which the arrangement of the liquid crystal molecules returns to an initial state. That is, the synchronous signal Sync is a signal generating at a starting point of a sustaining time. The synchronous signal Sync determines an applying time point of a plurality of first scan signals to be applied to the plurality of scan lines S1-Sp. Accordingly, the plurality of first scan signals are applied to the plurality of scan lines S1-Sp at a delayed time point due to a rising time from a time point at which a gate signal is first applied to a plurality of liquid crystal pixels PX corresponding to each of the plurality of gate lines G1-Gn. Accordingly, even if a pixel voltage corresponding to the input video signals R, G, and B is applied for a rising time, all of a plurality of light emitting pixels EPX of the light emitting device 100 are turned off, thereby reducing or even preventing a motion blur phenomenon.

The segment detection signal ID is a signal that is generated for a sustaining time. The segment detection signal ID allows a plurality of second scan signals that are applied to the plurality of scan lines S1-Sp to be applied within a sustaining time. A time interval between a first scan signal and a second scan signal corresponding to each of the plurality of scan lines S1-Sp is adjusted in consideration of a pulse width of the segment detection signal ID. For example, if a pulse width of the segment detection signal ID is 6 ms, a time interval between the first scan signal and the second scan signal can be determined to be 3 ms. In this way, a scan signal is applied two times to each of the plurality of scan lines S1-Sp, and two applications of scan signals occur within a sustaining time, thereby reducing or even preventing a flicker phenomenon.

The liquid crystal panel assembly 300 includes a plurality of signal lines G1-Gn and D1-Dm, and a plurality of liquid crystal pixels PX that are connected thereto and that are arranged in substantially a matrix form from an equivalent circuit view. The signal lines G1-Gn and D1-Dm include a plurality of gate lines G1-Gn that transfer a gate signal (hereinafter, may be referred to as a “scan signal”) and a plurality of data lines D1-Dm that transfer a data voltage. The gate lines G1-Gn extend in substantially a row direction and are substantially parallel to each other, and the data lines D1-Dm extend in substantially a column direction and are substantially parallel to each other.

Referring to FIG. 2, each liquid crystal pixel PX, for example, a liquid crystal pixel PXij that is connected to an i-th (i=1, 2, n) gate line Gi and a j-th (j=1, 2, m) data line Dj, includes a switch Q that is connected to signal lines Gi and Dj and a liquid crystal capacitor Clc and a storage capacitor Cst that are connected to the switch Q. The storage capacitor Cst may be omitted, as needed.

The switch Q is a three terminal element such as a thin film transistor that is provided in a lower display panel 310, and a control terminal thereof is connected to the gate line Gi, an input terminal thereof is connected to the data line Dj, and an output terminal thereof is connected to the liquid crystal capacitor CIc and the storage capacitor Cst.

The liquid crystal capacitor Clc uses a pixel electrode 308 of the lower display panel 310 and a common electrode 302 of an upper display panel 306 as two terminals, and there is a liquid crystal layer between two electrodes 302 and 308. The pixel electrode 308 is connected to the switch Q, and the common electrode 302 is formed in a front surface of the upper display panel 306 and receives a common voltage Vcom. Unlike a case of FIG. 2, the common electrode 302 may be provided in the lower display panel 310, and in this case, at least one of the two electrodes 302 and 308 may be formed in a linear shape or a bar shape.

The sustain capacitor Cst that performs a function as an assistant of the liquid crystal capacitor Clc is formed by overlapping a separate signal line and the pixel electrode 308 that are provided in the lower display panel 310 while disposing an insulator therebetween, and a voltage (or a predetermined voltage) such as a common voltage Vcom is applied to the separate signal line. However, the storage capacitor Cst is formed by overlapping the pixel electrode 308 with a front end gate line Gi-1 directly on the pixel electrode 308 using an insulator as an intermediary.

In order to embody color display in which each liquid crystal pixel PX inherently displays one of a plurality of primary colors (spatial division), or in which each liquid crystal pixel PX sequentially alternately displays a plurality of primary colors (temporal division), a desired color can be recognized with a spatial or temporal combination of the primary colors. The primary colors may include, for example, three primary colors of light, such as red, green, and blue colors. FIG. 2 illustrates an example of a spatial division and shows that each liquid crystal pixel PX has a color filter 304 representing one of primary colors in an area of the upper display panel 306 corresponding to the pixel electrode 308. The present invention, however, is not thereby limited, and the color filter 304 may be disposed in an upper part or a lower part of the pixel electrode 308 of the lower display panel 310. At least one polarizer is also provided in the liquid crystal panel assembly 300.

Referring again to FIG. 1, the gray voltage generator 800 generates all gray voltages or gray voltages of a limited number (hereinafter, referred to as “reference gray voltages”) that are related to transmittance of the liquid crystal pixel PX. The reference gray voltages may have a positive value and/or a negative value relative to a common voltage Vcom.

The gate driver 400 is connected to gate lines G1-Gn of the liquid crystal panel assembly 300 to apply a gate signal consisting of a combination of a gate-on voltage Von and a gate-off voltage Voff to the gate lines G1-Gn.

The data driver 500 is connected to data lines D1-Dm of the liquid crystal panel assembly 300, selects a gray voltage from the gray voltage generator 800, and applies the gray voltage as a data voltage to the data lines D1-Dm. However, when the gray voltage generator 800 provides reference gray voltages of a limited number instead of providing all gray voltages, the data driver 500 generates a desired data voltage by dividing a reference gray voltage.

The signal controller 600 controls the gate driver 400 and the data driver 500. The signal controller 600 appropriately processes the input video signals R, G, and B to correspond to an operation condition of the liquid crystal panel assembly 300 based on the input video signals R, G, and B and the input control signal CP that are received from the video processor 150, thereby generating a digital video signal DATA, a gate control signal CONT1, and a data control signal CONT2. The signal controller 600 transmits the generated gate control signal CONT1 to the gate driver 400, and transmits the data control signal CONT2 and the processed digital video signal DATA to the data driver 500.

The gate control signal CONT1 includes a scanning start signal STV that instructs the scanning start and at least one clock signal that controls an output period of a gate-on voltage Von. The gate control signal CONT1 may further include an output enable signal OE that limits a duration time of a gate-on voltage Von.

The data control signal CONT2 includes a horizontal synchronization start signal STH that notifies the start of transmitting a digital video signal DATA for liquid crystal pixels PX of a row to the data driver 500, and a load signal LOAD that instructs to apply an analog data voltage to the data lines D1-Dm. The data control signal CONT2 may further include a reversal signal RVS that inverts a polarity of a data voltage to a common voltage Vcom (hereinafter, a “polarity of a data voltage to a common voltage” is abbreviated to a “polarity of a data voltage”).

The data driver 500 generates an analog data voltage by selecting a gray voltage corresponding to the digital video signal DATA and applies the analog data voltage to the corresponding data lines D1-Dm.

The gate driver 400 applies a gate-on voltage Von to the gate lines G1-Gn according to the gate control signal CONT1 from the signal controller 600, thereby turning on a switch Q that is connected to the gate lines G1-Gn. Accordingly, a data voltage that is applied to the data lines D1-Dm is applied to the corresponding liquid crystal pixel PX through the turned on switch Q.

The difference between a data voltage and a common voltage Vcom that are applied to the liquid crystal pixel PX is represented as a charge voltage, i.e., a pixel voltage of the liquid crystal capacitor Clc. Liquid crystal molecules have different arrangements according to a magnitude of a pixel voltage, and thus polarized light of light that passes through the liquid crystal layer changes. The change of the polarized light is represented with a transmittance change of light by a polarizer, and thus the liquid crystal pixel PX displays luminance that is represented by a gray (or a gray level) of a digital video signal DATA.

By repeating such a process using one horizontal period (may be called “1H”, and is the same as a period of a horizontal synchronization signal Hsync and a data enable signal DE) in units, a gate-on voltage Von is sequentially applied to all gate lines G1-Gn and a data voltage is applied to all liquid crystal pixels PX, thereby displaying an image of a frame.

The light emitting device 100 includes a controller 110, a column driver 112, a scan driver 114, and a display unit 116. The controller 110 generates a light emitting signal CLS by reading a brightness information signal LS, and generates a scanning driving control signal CS and a column driving control signal CC by reading a synchronous signal Sync and a segment detection signal ID. The scanning driving control signal CS includes a scanning start signal STV1 that instructs the scanning start to each of the plurality of scan lines S1-Sp, and at least one clock signal that controls an output period of a scan-on voltage VN. The scanning driving control signal CS according to the present exemplary embodiment has a frequency that is two times greater than that of the gate control signal CONT1. The column driving control signal CC includes a horizontal synchronization start signal STH1 that controls the start of transmitting a light emitting signal CLS to the column driver 112 to pixels EPX of a row, and a load signal LOAD that controls a light emitting data voltage according to the light emitting signal CLS to be applied to column lines C1-Cq.

The column driver 112 is connected to a plurality of column lines C1-Cq, and controls the light emitting pixels EPX to emit light to correspond to grays (or gray levels) of a plurality of liquid crystal pixels PX corresponding to the light emitting pixels EPX according to the column driving control signal CC and the light emitting signal CLS. Specifically, the column driver 112 determines a pulse width of a plurality of light emitting data voltages according to the light emitting signal CLS, and transfers the pulse width to the plurality of column lines C1-Cq according to the column driving control signal CC. That is, the column driver 112 synchronizes the light emitting pixel EPX to emit light with a certain or predetermined gray (or a certain or predetermined gray level) to correspond to an image that is displayed in the plurality of liquid crystal pixels PX corresponding to one light emitting pixel EPX. The scan driver 114 is connected to the plurality of scan lines S1-Sp, and transfers a plurality of scan signals so that the light emitting pixels EPX emit light to synchronize with the corresponding plurality of liquid crystal pixels PX according to the scanning driving control signal CS.

The display unit 116 includes a plurality of scan lines S1-Sp that transfer a scan signal and a plurality of column lines C1-Cq and a plurality of light emitting pixels EPX that transfer a light emitting data signal. Each of the plurality of light emitting pixels EPX is positioned at an area that is defined by the scan lines S1-Sp and column lines C1-Cq crossing (or intersecting) the scan lines S1-Sp. Each of the plurality of light emitting pixels EPX according to the present exemplary embodiment is formed with a field emission array (hereinafter, referred to as an FEA) type of electron emission element. The FEA type of electron emission element includes an electron emission region and a phosphor layer that are electrically connected to a scan electrode and a data electrode, or at least one of a scan electrode or a data electrode. The electron emission region may be made of a material having a low work function or a large aspect ratio, for example, a carbon-based material and/or a nanometer (nm) sized material. The FEA type of electron emission element forms an electric field around the electron emission region using a voltage difference between the scan electrode and the data electrode, emits electrons due to the electric field, and excites a phosphor layer with the emitted electrons, thereby emitting visible light of intensity corresponding to an electron beam emission amount.

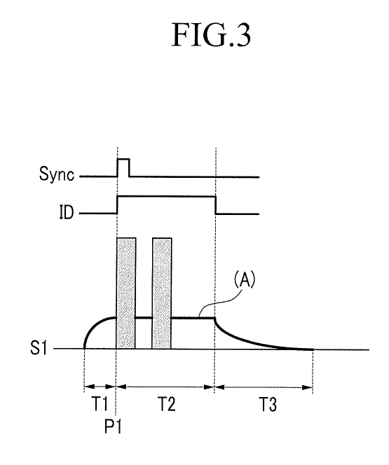

FIG. 3 is a diagram illustrating a synchronous signal Sync, a segment detection signal ID, and a scan signal that is supplied to a plurality of scan lines S1-Sp according to an exemplary embodiment. For better understanding and ease of description, FIG. 3 illustrates a scan signal that is applied to a scan line S1 of the plurality of scan lines S1-Sp. In FIG. 3, (A) indicates a response characteristic curve of the liquid crystal panel assembly 300 during a frame period. Here, in the frame period, a period T1 is a rising time, a period T2 is a sustaining time, and a period T3 is a falling time. Referring to FIG. 3, a synchronous signal Sync occurs at a time point P1 at which the rising time T1 terminates and the sustaining time T2 starts. The synchronous signal Sync includes a pulse having a high level for a set or predetermined period. Accordingly, as a first scan signal is synchronized with the synchronous signal Sync, the first scan signal is applied to the scan line S1. A plurality of first scan signals that are applied to the remaining scan lines S2-Sp are sequentially applied at a set or predetermined time interval from a time point at which the first scan signal is applied to the scan line S1. Here, a time interval between the plurality of first scan signals that are applied to the plurality of scan lines S1-Sp is substantially identical to a time interval between a plurality of gate signals that are applied to a plurality of gate lines G1-Gn. The segment detection signal ID occurs from a time point at which the rising time T1 terminates to a time point at which the sustaining time T3 starts. Accordingly, a second scan signal is applied to the scan line 51 within the time period of the application of the segment detection signal ID. Similarly, a plurality of second scan signals that are applied to the remaining scan line 52-Sp are also sequentially applied at a set or predetermined time interval. That is, according to the embodiment, by allowing a scan signal to be applied to the plurality of scan lines S1-Sp within the sustaining time T2 of liquid crystal, a motion blur phenomenon can be reduced or even prevented. Further, by applying two separate scan signals for a frame period to the plurality of scan lines S1-Sp (or to each of the plurality of scan lines S1-Sp) within the sustaining time T2 of liquid crystal, a flicker phenomenon can be improved.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A light emitting device configured as a light source for a display device comprising a plurality of liquid crystal pixels, the light emitting device comprising:
a display unit comprising a plurality of scan lines, a plurality of column lines crossing the plurality of scan lines, and a plurality of light emitting pixels at crossing regions of the plurality of scan lines and the plurality of column lines and configured to provide light to at least one of the plurality of liquid crystal pixels, wherein each of the plurality of scan lines is configured to be applied with a first scan signal and a second scan signal for a frame period; and
a partial brightness controller configured to generate a synchronous signal and a segment detection signal, the synchronous signal and the segment detector signal being for controlling application time points of the first and second scan signals according to a liquid crystal response speed on an operation mode basis of the display device,
wherein the first scan signal is applied at a time point of the application time points at which liquid crystal arrangement of the plurality of liquid crystal pixels starts to be sustained, and the second scan signal is applied within a time period in which the liquid crystal arrangement is sustained.

2. The light emitting device of claim 1, wherein the liquid crystal response speed comprises a rising time, a sustaining time, and a falling time; wherein the rising time is a time period from a time point at which a voltage is applied to the display device until the liquid crystal arrangement changes from an initial state to a sustain state; wherein the sustaining time is a time period in which the liquid crystal arrangement is in the sustain state; and wherein the falling time is a time period from a time point at which the application of the voltage to the display device is terminated until the liquid crystal arrangement returns to the initial state.

3. The light emitting device of claim 2, wherein the partial brightness controller is configured to generate and apply the synchronous signal at a time point at which the rising time terminates.

4. The light emitting device of claim 2, wherein the partial brightness controller is configured to generate and apply the segment detection signal from a time point at which the rising time terminates until a time point at which the falling time starts.

5. The light emitting device of claim 2, wherein the partial brightness controller is configured to generate and apply the synchronous signal at a time point at which the rising time terminates, and wherein the partial brightness controller is configured to generate and apply the segment detection signal from a time point at which the rising time terminates until a time point at which the falling time starts.

6. The light emitting device of claim 1, further comprising a controller configured to apply the first scan signal to each of the plurality of scan lines at a time point at which the synchronous signal is applied and to apply the second scan signal to each of the plurality of scan lines within a time period in which the segment detection signal is applied.

7. A method of driving a light emitting device comprising a plurality of scan lines, a plurality of column lines, and a plurality of light emitting pixels configured to provide a light to at least one of a plurality of liquid crystal pixels of a display device, the method comprising:
applying a first scan signal and a second scan signal to each of the plurality of scan lines for a frame period; and
generating a synchronous signal and a segment detection signal for controlling application time points of the first and second scan signals according to a liquid crystal response speed on an operation mode basis of the display device,
wherein the first scan signal is applied at a time point of the application time points at which liquid crystal arrangement of the plurality of liquid crystal pixels starts to be sustained, and the second scan signal is applied within a time period in which the liquid crystal arrangement is sustained.

8. The method of claim 7, wherein the liquid crystal response speed comprises a rising time, a sustaining time, and a falling time; wherein the rising time is a time period from a time point at which a voltage is applied to the display device until the liquid crystal arrangement changes from an initial state to a sustain state; wherein the sustaining time is a time period in which the liquid crystal arrangement is in the sustain state; and wherein the falling time is a time period from a time point at which the application of the voltage to the display device is terminated until the liquid crystal arrangement returns to the initial state.

9. The method of claim 8, further comprising generating the synchronous signal at a time point at which the rising time terminates.

10. The method of claim 8, further comprising generating the segment detection signal from a time point at which the rising time terminates until a time point at which the falling time starts.

11. The method of claim 8, further comprising:
generating the synchronous signal at a time point at which the rising time terminates; and
generating the segment detection signal from a time point at which the rising time terminates until a time point at which the falling time starts.

12. A light emitting device configured as a light source for a display device comprising a liquid crystal pixel, the light emitting device comprising:
a display unit comprising a scan line and a light emitting pixel coupled to the scan line and configured to provide light to the liquid crystal pixel, wherein the scan line is configured to be applied with a first scan signal and a second scan signal for a frame period; and
a partial brightness controller configured to generate a synchronous signal and a segment detection signal, the synchronous signal and the segment detector signal being for controlling application time points of the first and second scan signals according to a liquid crystal response speed on an operation mode basis of the display device,
wherein the first scan signal is applied at a time point of the application time points at which a liquid crystal arrangement of the liquid crystal pixel starts to be sustained, and the second scan signal is applied within a time period in which the liquid crystal arrangement is sustained.

13. The light emitting device of claim 12, wherein the liquid crystal response speed comprises a rising time, a sustaining time, and a falling time; wherein the rising time is a time period from a time point at which a voltage is applied to the display device until the liquid crystal arrangement changes from an initial state to a sustain state; wherein the sustaining time is a time period in which the liquid crystal arrangement is in the sustain state; and wherein the falling time is a time period from a time point at which the application of the voltage to the display device is terminated until the liquid crystal arrangement returns to the initial state.

14. The light emitting device of claim 13, wherein the partial brightness controller is configured to generate and apply the synchronous signal at a time point at which the rising time terminates.

15. The light emitting device of claim 13, wherein the partial brightness controller is configured to generate and apply the segment detection signal from a time point at which the rising time terminates until a time point at which the falling time starts.

16. The light emitting device of claim 12, wherein the partial brightness controller is configured to generate and apply the synchronous signal at a time point at which the rising time terminates, and wherein the partial brightness controller is configured to generate and apply the segment detection signal from a time point at which the rising time terminates until a time point at which the falling time starts.

17. The light emitting device of claim 10, further comprising a controller configured to apply the first scan signal to the scan line at a time point at which the synchronous signal is applied and to apply the second scan signal to the scan line within a time period in which the segment detection signal is applied.
